(19) United States
(12) Patent Application Publication
(10) Pub. No.: US 2026/0160497 A1
(43) Pub. Date: Jun. 11, 2026

(54) GLASS FURNACE

(71) Applicant: SAINT-GOBAIN ISOVER, COURBEVOIE (FR)

(72) Inventor: Philippe DE DIANOUS, COURBEVOIE (FR)

(21) Appl. No.: 19/124,097

(22) PCT Filed: Oct. 24, 2023
(86) PCT No.: PCT/EP2023/079691

§ 371 Date: Apr. 24, 2025

(30) Foreign Application Priority Data
Oct. 25, 2022 (FR) FR2211071
Nov. 30, 2022 (FR) FR2212583

(51) Int. Cl. F27D 17/30; C03B 5/42; F27D 1/02; F27D 19/00

(52) U.S. Cl. CPC F27D 17/302; C03B 5/42; F27D 1/02; F27D 19/00; F27D 2019/0031

(57) ABSTRACT

A module for evacuating smoke from an enclosure, including a main duct, wherein the module further includes a support base on which the main duct rests, the duct being surmounted by a variable duct closure system.

The invention relates to a glass furnace.

### PRIOR ART

The invention relates to a device for melting a vitrifiable material, in particular for use in the production of flat glass, hollow glass or insulating fibers, hereinafter referred to as a glass furnace.

Such a furnace consists of a tank that is surmounted by a superstructure. The tank is the area in which the raw material is melted. The superstructure is a structure placed on the tank to form an enclosed area. This superstructure thus comprises a side wall and a crown closing the furnace from above.

This side wall and this crown are made of masonry, that is they consist of blocks masonryed together, each block being made of a material resistant to high temperatures such as concrete.

The operation of such a furnace generates smoke that must be evacuated. To do this, at least one chimney is arranged on the superstructure. This chimney consists of a masonry duct with a crown that allows for the suction of the smoke.

Such a masonry crown with at least one masonry chimney is therefore imposing and requires a substantial support structure.

### SUMMARY OF THE INVENTION

The purpose of the present invention is to provide a glass furnace that provides an optimized smoke extraction system.

To this end, the invention relates to a module for evacuating smoke from an enclosure comprising a main duct characterized in that the module further comprises a support base on which the main duct rests, the duct being surmounted by a variable duct closure system.

In one example, the main duct is sealed to the support base.

In one example, the main duct is attached to an external structure.

In one example, the main duct comprises a metal shell enclosing a masonry duct.

The invention further relates to a glass furnace comprising a tank surmounted by a side wall and closed from above by a crown, said crown being supported by an external structure, characterized in that the crown supports the chimney evacuation module according to one of the preceding claims.

In one example, the crown comprises a plurality of individual elements attached directly to the external structure.

In one example, the individual elements of a same line are provided with interlocking means to fit together.

In one example, the interlocking means comprise complementary surfaces.

In one example, the support base comprises complementary surfaces for interlocking with at least one individual element.

In one example, the side wall comprises at least one rotatably mounted panel.

In one example, the rotatably mounted panel and/or the variable duct closure system are connected to a control unit which controls them in order to adapt the pressure in the furnace and/or the outgoing smoke flow.

In one example, the furnace comprises an inlet opening in the so-called upstream face, said furnace being separated into two upstream and downstream zones by an axis parallel to said upstream face, said at least one evacuation module being arranged in the downstream zone.

### DESCRIPTION OF THE FIGURES

Other particular features and advantages will become clear from the following description thereof, given by way of indication and in an entirely non-limiting manner, with reference to the appended drawings, wherein:

FIG. 1 shows a view of a furnace;

FIGS. 2 and 3 schematically show a smoke evacuation module according to the invention;

FIGS. 4 to 6 schematically show variants of a smoke evacuation module according to the invention;

FIG. 7 schematically shows a smoke evacuation module equipped with a variable outlet according to the invention;

FIG. 8 schematically shows a crown of a furnace according to the invention;

FIGS. 9 to 12 show different views of an individual element of a crown for a furnace according to the invention;

FIGS. 13a, 13b, 13c, 13d and 13e show different variants of a mobile panel according to the invention;

FIG. 14 schematically show a smoke evacuation module associated with a crown fitted with individual elements according to the invention;

FIGS. 15 and 16 depict a top view of a furnace according to the invention;

FIGS. 17 and 18 depict a side view of a furnace equipped with mobile panels and a downstream smoke evacuation module according to the invention;

### DETAILED DESCRIPTION OF THE INVENTION

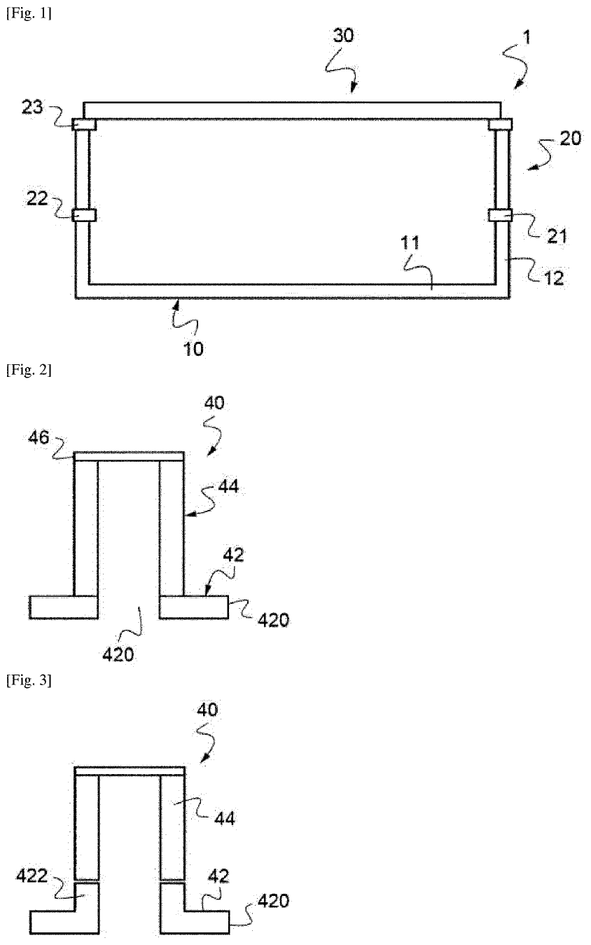

The invention depicted in FIG. 1 relates to a glass furnace 1. Such a glass furnace comprises a tank 10 in which the raw material is melted. This tank 10 has a footprint extending along two perpendicular directions. The tank thus has a square or rectangular shaped footprint. This tank is formed of a base 11 and vertical walls 12, each made of layers of materials resistant to the temperatures of the molten raw material such as refractory materials like concrete. These refractory materials can be sintered or electromelted.

The furnace further comprises a side wall 20 surmounting this tank. This side wall is in contact with a tank extension 21 acting as a stop for said side wall. The side wall comprises panels 22 and inserts, these inserts allowing the placement of functional elements such as probes or burners or electrodes or sight holes.

Each panel 22 comprises two parallel faces 22a (internal, external) and a peripheral edge 22b comprising a top portion, a bottom portion and two side portions. The panels and the inserts are in contact with each other at their edges, and the interface therebetween is insulated by the placement of a material preventing smoke and/or dust infiltration.

The side wall is then surmounted by a cornice 23. Finally, the furnace is closed from above by a crown 30 in contact with the cornice 23.

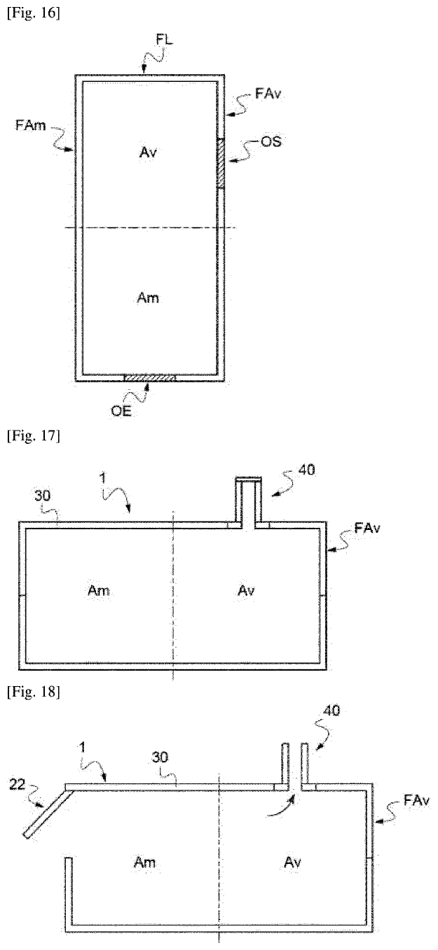

The furnace further comprises an inlet opening OE through which the raw material is fed and an outlet through which the molten material exits. The inlet opening is located on the upstream face FAm. The face opposite the upstream face is called the downstream face FAv. The outlet opening OS is located on the downstream face FAv or on another face known as the side face FL as can be seen in FIGS. 15 and 16.

According to the invention, the furnace comprises a smoke evacuation module 40. Such a smoke evacuation module comprises a support base 42, a main duct 44 and an outlet modulation unit of the system 46 as can be seen in FIG. 2.

The support base 42 is the part of the module that is integral with the crown. This support base 42 consists of a block of refractory material. This block comprises a central opening 420. This support block 42 is in the form of a plate from which a duct 422 extends, orthogonally to the plane of said plate as can be seen in FIG. 3. This duct is identical in shape to that of the central opening.

The plate forming the support block 42 comprises a peripheral edge 420 for integration into the crown.

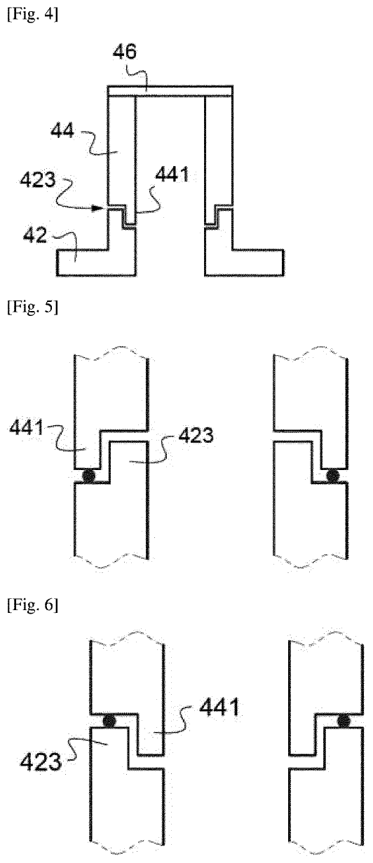

The duct 422 of the support base 42 comprises a shoulder 423 on which the main duct rests. This main duct 44 also comprises a shoulder 441 on its surface in contact with the support base 42 as can be seen in FIGS. 4 to 6. A mortar or fiber joint is used to seal the support base and the main duct.

The main duct 44 is surmounted by an outlet flow adjustment unit 46. This outlet flow adjustment unit 46 is used to open the chimney more or less as required. This unit can take a variety of forms.

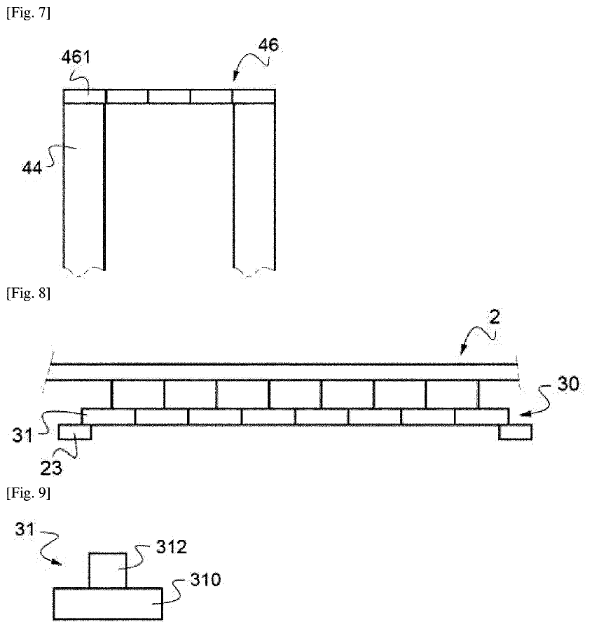

A first form consists of metal strips 461 or refractory material arranged side by side to plug the main duct as can be seen in FIG. 7. These strips are added or removed manually or by a motorized system controlled by a control unit.

In a second form, the flow control unit 46 consists of a plate sliding over the main duct. This sliding plate is motorized and may or may not be controlled by a control unit and moves over the main duct to partially or totally obstruct it. This second form offers the advantage of facilitating a finer adjustment.

In one variant, the support base 42 is arranged to form part of a modular crown 30. Such a crown is composed of individual elements 31 assembled together. These individual elements 31 are supported by an external structure 2 as can be seen in FIG. 8. This external structure 2 may comprise at least one metal beam extending above said crown. Each individual element 31 takes the form of a block.

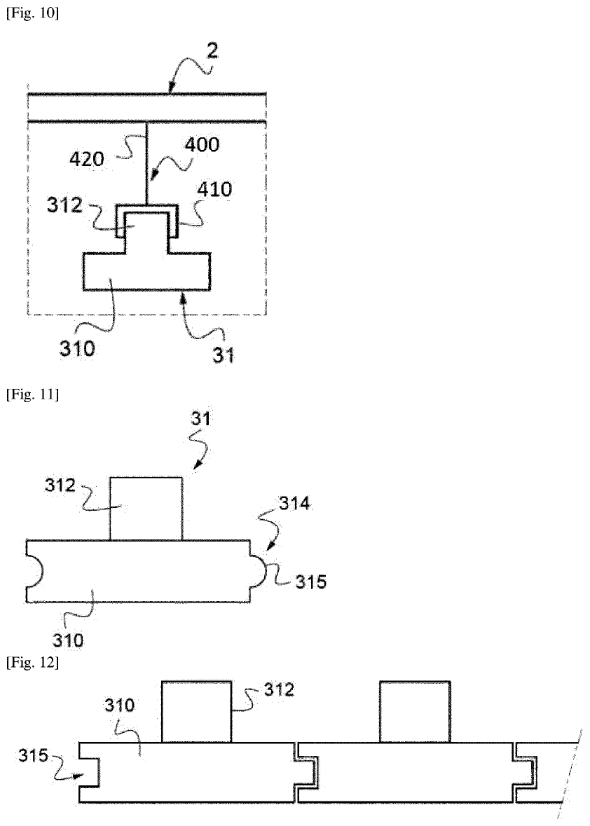

Each individual element 31 comprises a first part and a second part as shown in FIG. 9. The first part takes the form of a plate 310 and is used to form the lower surface of the crown. The second part is used to attach the individual elements to the external structure. This second part is in the form of a coupling head 312. The coupling head 312 is integral with the plate 310, preferably of the same material as said plate 310. In the case of a coupling head made of the same material as the plate 310, the coupling head and the plate 310 are molded together. Preferably, the coupling head 312 is centered on the plate with respect to at least one axis. The coupling head 312 allows coupling means 400 to attach said individual element to the structure as can be seen in FIG. 10. These coupling means 400 comprise a clip 410 which grips the coupling head. The coupling head 312 and the clip 410 are shaped to enable said clip to support the coupling head. For example, the coupling head has a spherical cross-section and the clip comprises two curved arms. In the case of a spherical coupling head, it is then possible to give the individual element a slight inclination. This gives the crown its curvature or helps with the placement of individual elements.

One advantage of having an individual element comprising a first part and a second part is that the functions can be dissociated. In fact, the individual element according to the invention has a first part which is used as a structuring element of the crown while the second part is dedicated to coupling said individual element. Thus, the use of coupling means 40 coupled to the second part in the form of coupling head 312 by screwing would not result in a loss of performance of the individual element, which would require compensation such as an increase in the thickness of the individual element.

This clip 410 is attached to the end of a rod 420, which is itself attached to the external structure 2. This attachment is for example achieved by bolting. It is understood that each individual element 31 is suspended independently from the external structure 2. This ensures optimum support and can withstand the breakage of a clip on an individual element without affecting the crown. This also gives greater flexibility/adaptability to the assembly, as the rods compensate for possible misalignment of the heads in relation to the coupling holes on the external structure 2.

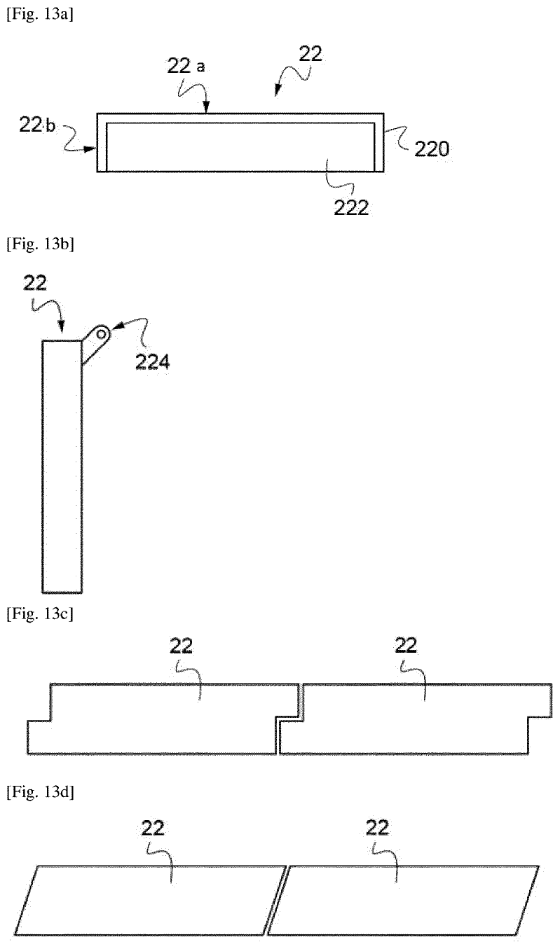

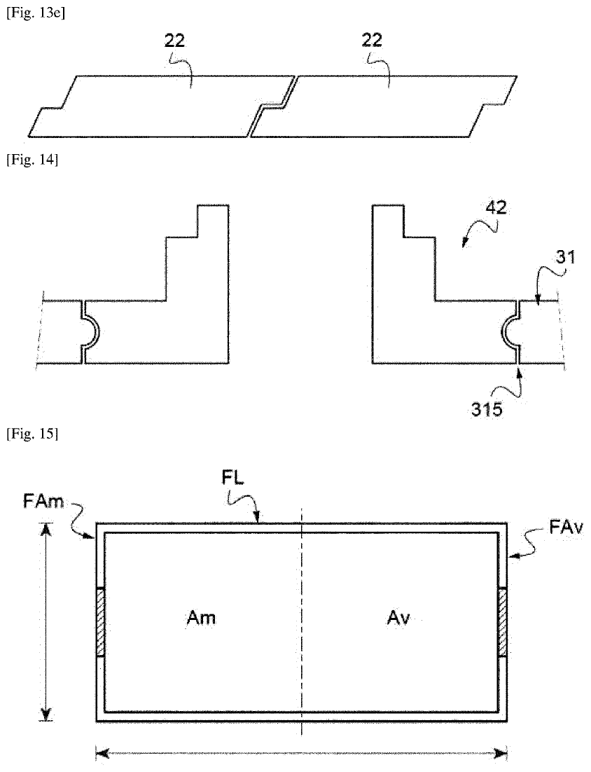

The plate 310 of the first part is square or rectangular shaped with dimensions of 20 to 80 cm on a side and a thickness of 15 to 30 cm. This plate is clever in that it has, on at least two sides, interlocking means 314 as can be seen in FIG. 11. These interlocking means 314 take the form of two complementary surfaces 315 of the male-female type such as for example a hollow and a semicircle which join together. Each plate thus comprises, on a first side, a first complementary surface and on the opposite side, a second complementary surface. These sides can be adjacent or opposite. This allows the plates to be combined in order to align them as can be seen in FIG. 12. A refractory type I material is placed between the plates. The complementary surfaces of the same plate can be arranged on opposite sides. Preferably, the four sides of a plate 310 are provided with complementary surfaces 315, which may or may not be arranged oppositely. It is understood that the complementary male and female surfaces can be arranged on adjacent sides. The complementary surfaces 315 are arranged so that a gap remains between the plates of two assembled individual elements 31. This space is used as an expansion joint, that is to compensate for the expansion of individual elements under the effect of heat. To seal the crown 30, plates 33 or sealing means are arranged on the plates 310 above the space between two plates 310 as can be seen in FIG. 13. These spaces are filled with heat-resistant compressible material (ordinary fibers), these joints closing as the crown expands. The spaces between the individual elements are not all the same.

Complementary surfaces 315 also reduce the risk of fumes passing through.

The complementary surfaces can be arranged to allow a degree of freedom in the positioning of the individual elements, that is to allow an angular offset between two individual elements.

This alignment of the plates is made according to at least one of the directions of the furnace, namely the width or the length. Thus, the crown 30 is composed of several parallel lines extending in one of the directions of the furnace, preferably the shortest.

In one variant, the plates of two adjacent lines are staggered.

In another variant, the plates are grouped together in the form of a module. To reinforce the crown, a certain number of plates can be joined with mortar M. This mortar is placed between two plates, on the sides bearing the complementary surfaces or on other sides. This mortar reinforces the solidity of the crown. This mortar reinforces the solidity of the crown and prevents gas infiltration between plates.

To manage the overall expansion of the crown during tempering, the mortar is placed to form modules or zones, which are separated by open joints or filled with heat-resistant compressible material (ordinary fibers), these joints closing as the crown expands. It is then understood that the individual elements of the crown are grouped into zones. The individual elements of a zone are sealed together with mortar, while the different zones are not sealed with the adjacent zone(s).

In a variant shown in FIGS. 13a and 13b, the panels 22 forming the side wall are mounted so as to be mobile. More particularly, the panels are pivotably mounted. For this purpose, each panel consists of a metal frame 220 on which a concrete-type heat-resistant material 222 is placed. This material is molded onto this frame to form a plate, the latter being fitted with hooks overmolded with concrete to securely attach said material to the frame. The frame is then provided with two drilled extensions 224 so that an axis can be inserted to make the panel rotatable. A pulley system is used to rotate the panel. This ability to rotate the panel(s) simplifies furnace maintenance.

This pulley system can be controlled manually or be motorized. In the case of motorized pulleys, a control unit, like the one driving the flow control unit, is used to control the pulley system of the panels.

In a particular embodiment of these panels, one or more lateral portions of the peripheral edge 22b is not perpendicular to the external face of said panel. This lateral portion may be angled and/or have a stepped profile as can be seen in FIGS. 13 c, 13 d and 13 e. A stepped profile consists of a profile having a notch. The lateral portion can combine an angle and a notch.

Thus, two adjacent panels are arranged so that their contacting side portions are complementary.

Consequently, the support base 42 of the smoke evacuation system according to the invention also comprises at least two complementary surfaces 315 at its sides as can be seen in FIG. 14. These complementary surfaces are arranged to engage with those of adjacent individual element(s) 31.

In another variant, the smoke evacuation module 40 is partially supported by the external structure 2. To do this, the main duct 44 consists of a metal shell enclosing walls made of refractory material. This metal shell allows the attachment of at least one wedge. This wedge is positioned on the main duct so that, when the duct is in place, it is in contact with the external structure 2. The wedge is then placed on the structure or suspended therefrom, and may or may not be attached by screws or rivets. This variant advantageously allows part of the mass of the smoke evacuation module 40 to be supported by the external structure. Thus, the crown does not have to be designed to support the entire mass of said smoke evacuation system.

The furnace according to the invention has a special configuration for implementing smoke evacuation. This particular configuration is such that the smoke evacuation module is positioned opposite the inlet opening OE in the crown. To do this, the furnace is considered to be divided into two parts by an axis or plane parallel to the upstream face FAm, that is, the face on which the inlet opening OE is arranged. Preferably, both parts are the same size. The upstream zone is therefore the zone of the furnace encompassing the upstream face. The smoke evacuation module 40 is therefore arranged in the downstream zone. Preferably, the evacuation module is positioned centrally with respect to this downstream zone. This means that for a furnace comprising a smoke evacuation module, this module is centered whereas for a furnace comprising two smoke evacuation modules, these are positioned centered and symmetrically on both sides of an axis.

This particular configuration further consists in having the upstream face, the face opposite the downstream face, feature mobile panels as can be seen in FIGS. 17 and 18. These mobile panels, on this upstream face, are used, open, to promote suction. Indeed, the mobile panels located on the upstream face can be opened to create an air intake, which induces suction in the main duct of the smoke extraction system. These panels are also used for other purposes such as passing a loading machine.

Partial opening of the chimney panels can be used to regulate the pressure of the furnace during tempering.

Of course, the present invention is not limited to the illustrated example but is susceptible to various variants and modifications which will become apparent to the person skilled in the art.

1. A module for evacuating smoke from an enclosure comprising a main duct and a support base on which the main duct rests, the duct being surmounted by a variable duct closure system.

2. The evacuation module according to claim 1, wherein the main duct is sealed to the support base.

3. The evacuation module according to claim 1, wherein the main duct is attached to an external structure.

4. The evacuation module according to claim 1, wherein the main duct comprises a metal shell enclosing a masonry duct.

5. A glass furnace comprising a tank surmounted by a side wall and closed from above by a crown, said crown (30) being supported by an external structure, wherein the crown supports at least one chimney evacuation module according to claim 1.

6. The glass furnace according to claim 5, wherein the crown comprises a plurality of individual elements attached directly to the external structure.

7. The glass furnace according to claim 6, wherein the individual elements of a same line of the crown are provided with interlocking means for interlocking with one another.

8. The glass furnace according to claim 7, wherein the interlocking means comprise complementary surfaces.

9. The glass furnace according to claim 8, wherein the support base of the chimney comprises complementary surfaces for interlocking with at least one individual element of the crown.

10. The glass furnace according to claim 9, wherein the side wall comprises at least one panel rotatably mounted by a pulley system.

11. The furnace according to claim 5, wherein the main duct of the smoke evacuation module comprises wedges enabling said main duct to be attached and supported by the external structure.

12. The furnace according to claim 10, wherein the rotatably mounted panel and/or the variable duct closure system are connected to a control unit which controls them to adapt the pressure in the furnace and/or the outgoing smoke flow.

13. The furnace according to claim 5 comprising an inlet opening on an upstream face, said furnace being separated into two upstream and downstream zones by an axis parallel to said upstream face, said at least one evacuation module being arranged in the downstream zone.
